(19) United States
(12) Patent Application Publication
(10) Pub. No.: US 2011/0320941 A1
(43) Pub. Date: Dec. 29, 2011

(54) STEREOSCOPIC 3D CONTENT AUTO-FORMAT-ADAPTER MIDDLEWARE FOR STREAMING CONSUMPTION FROM INTERNET

(76) Inventor: Sunil K. Jain, Portand, OR (US)

(21) Appl. No.: 12/973,554

(22) Filed: Dec. 20, 2010

Related U.S. Application Data
(60) Provisional application No. 61/350,297, filed on Jun. 1, 2010.

(51) Int. Cl. G06F 3/048; G06F 15/16

(52) U.S. Cl. 715/705; 709/218

(57) ABSTRACT

Stereoscopic (3D) content streaming on PC from internet may become a commonplace practice. However, expecting a user to learn which formats and eyewear type to select for a particular display configuration type may be a challenge. Embodiments automatically discovers the PC system configuration and content formats being delivered, and using content-to-display format matching, adapts the content for best viewing quality for the user. The interactive application backed by a library instructs the user to setup the viewing configuration and conditions for optimum quality, removing the confusion choices can produce otherwise.

### CROSS-REFERENCE TO RELATED APPLICATIONS

This application claims priority to U.S. Provisional Application Ser. No. 61/350,297, filed on Jun. 1, 2010, the contents of which are herein incorporated by reference.

### FIELD OF THE INVENTION

Embodiments of the present invention are directed to stereoscopic systems and, more particularly, to systems which allow a user to view a stereoscopic media in an optimum format.

### BACKGROUND INFORMATION

Humans have what is known as binocular vision owing to the fact that we have two eyes separated by a couple of inches. Each eye views the same scene from a slightly different perspective view each providing the brain with slightly different information. These two views are combined by the brain such that we perceive depth and see the world in three-dimensions (3D).

Electronically stored or transmitted visual images, such as pictures or video, is typically displayed on a two dimensional medium such as a television screen or other type of monitor or projected on to a screen. Both eyes view the same information. The brain is thus left to use other visual cues from the two-dimensional (2D) image, such as relative sizes of objects, shadow, perspective lines, or horizons, to name a few, to sense depth. However, the picture still looks flat and not like we see the real world.

Stereoscopy refers to any of various processes and devices for giving the illusion of depth from two-dimensional images. We say illusion because true 3D may be more like a hologram where you could walk around the image and change your perspective. However, when done correctly, stereoscopy can trick the brain into thinking objects are jumping out of the screen at you.

In its simplest form, two cameras, or one camera with two lenses, spaced a few inches apart, are used to capture two 2D images. Each 2D image, of course, is from a slightly different perspective such that when the left eye views one image and the right eye views the other, the brain combines the views and we see the combined image as three-dimensional (3D).

Big screen stereoscopic motion pictures or “3D movies”, as is the term more commonly used, are becoming quite popular again. In addition, 3D technologies are now available for home video with the so-called 3D TVs, video games, and streaming and recorded video content for computer monitor viewing.

There are several types of stereoscopic or “3D” technology available. Most require the viewer to wear special glasses or goggles. Some require active components in the glasses, others do not. Some require special monitors or drivers. Each has it pros and cons and, depending on the situation, may or may not make sense for a specific task.

Regardless of the technology used, the end goal is primarily to separate what the left and the right eye sees. Early technologies involved physical separation where a viewer looked into a binocular-like device, with a lens for each eye to physically separate the left and right views. This technique which may be the oldest, works quite well and a close variation of this technique is still used in modern virtual reality goggles or head-mounted displays. However, this is only good for one person or individual viewing and may be expensive or impractical for more than a couple viewers.

One of the first left/right (L/R) separation technologies good for the masses was spectral separation. The technical term is “color anaglyph” and involved each viewer wearing a pair of glasses with a red filter for one eye and a blue filter for the other. The left and right images were likewise blue or red encoded and displayed simultaneously. This technique was popular for producing 3D movies in the 1950s and even works to some degree with standard color televisions or monitors. While providing a novelty for its day, it left much to be desired aesthetically. The end result tended to be monochromatic, and had a lot of ghosting (i.e. the L/R separation was not clean). On the pro side, it was inexpensive to produce and the glasses were passive and very inexpensive.

Similar to spectral separation, the next most common technique is spatial separation and involves the viewers wearing polarized glasses, with each eye lens being polarized at 45 degrees, for example, to the other or circularly polarized in opposite directions. This is the technology used most often today in movie theaters. It works pretty well with the L/R separation being fairly complete, but usually requires two projectors or a special projector in a theatre setting or a few additional layers in a monitor which adds cost. Also, each eye only sees half resolution which may degrade the viewing experience. On the pro side, the polarized glasses are again passive and therefore relatively inexpensive.

FIG. 1 shows a typical multimedia presentation one might view over the internet. The figure shown in from Youtube, a popular web site which users can upload, share, and view videos. Many other such services are also available. Presently, most images are presented in familiar 2D. However, in the future, 3D content over the internet or other delivery systems are contemplated which may require special eyewear to view properly. Stereoscopic content streaming on PC from internet from portals such as Youtube will become a commonplace practice. However, expecting a mainstream PC user to learn which formats and eyewear type to select for which display configuration type is a huge challenge. Even the subject matter expert users struggle in making the correct choice amongst the large number of permutations possible.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is a sample of a typical multimedia presentation one might view over the internet using a browser;

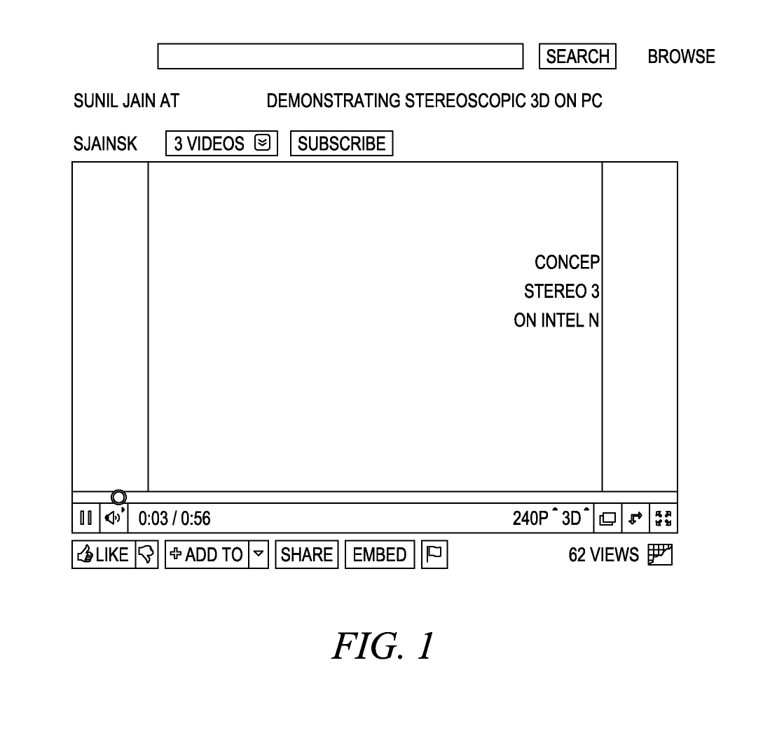

FIG. 2 shows the components or modules of a stereoscopic 3D content auto format adapter according to one embodiment; and

FIG. 3 shows the modules of FIG. 2 illustrated in one possible system configuration.

### DETAILED DESCRIPTION

Described is system and method, such as a piece of middleware, embedded between the internet browsers and the graphics drivers, that automatically makes or instructs the user how to make the optimum viewing choices for 3D viewing.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of the invention may be directed to a middleware that can be embedded between the internet browser and the graphics driver or can also be implemented as an extension to the graphics driver or as an extension of the browser.

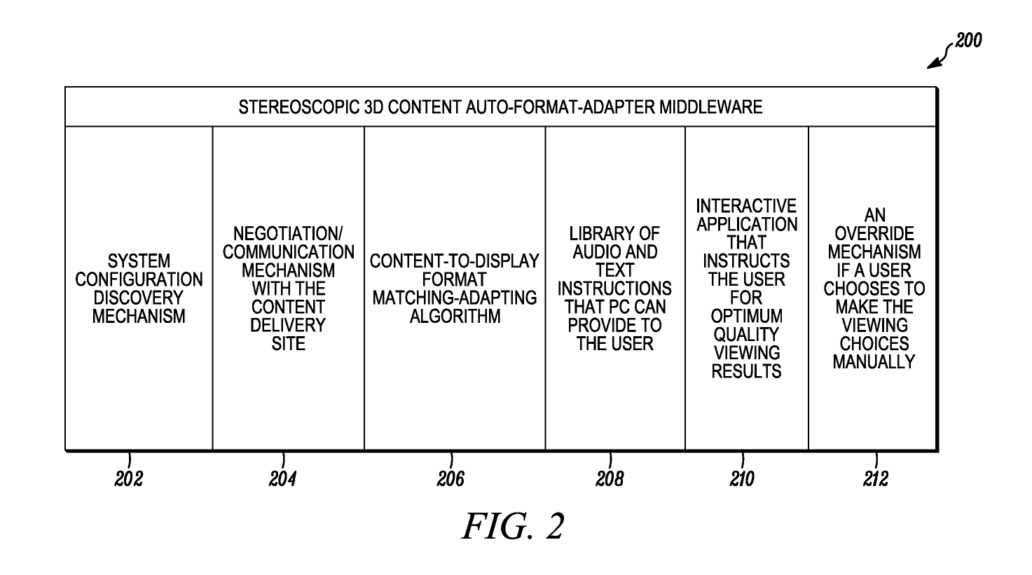

Referring now to FIG. 2, there is shown the components or modules of a stereoscopic 3D content auto format adapter 200. The first component may comprise a system configuration discovery mechanism 202. This component may determine the platform and the platform capabilities of the viewing computer device or PC. Next, a negotiation/communication mechanism 204 may be provided to communicate with the content delivery site to determine available formats of the stereoscopic content to be viewed. Next, a Content-to-display format matching-adapting mechanism 206 to match the format of the stereoscopic content from the site to the capabilities of the viewing computer may be provided. A library of audio and text instructions 208 may be provided that the PC can provide to the user to instruct them on the optimum method for viewing the video. An interactive application 210 may also be provided that instructs the user for optimum quality viewing results. For example, it may instruct the user the proper goggles or settings to provide the richest viewing experience for the video being watched. Finally, an override mechanism 212 may be provided if a user chooses to make the viewing choices manually.

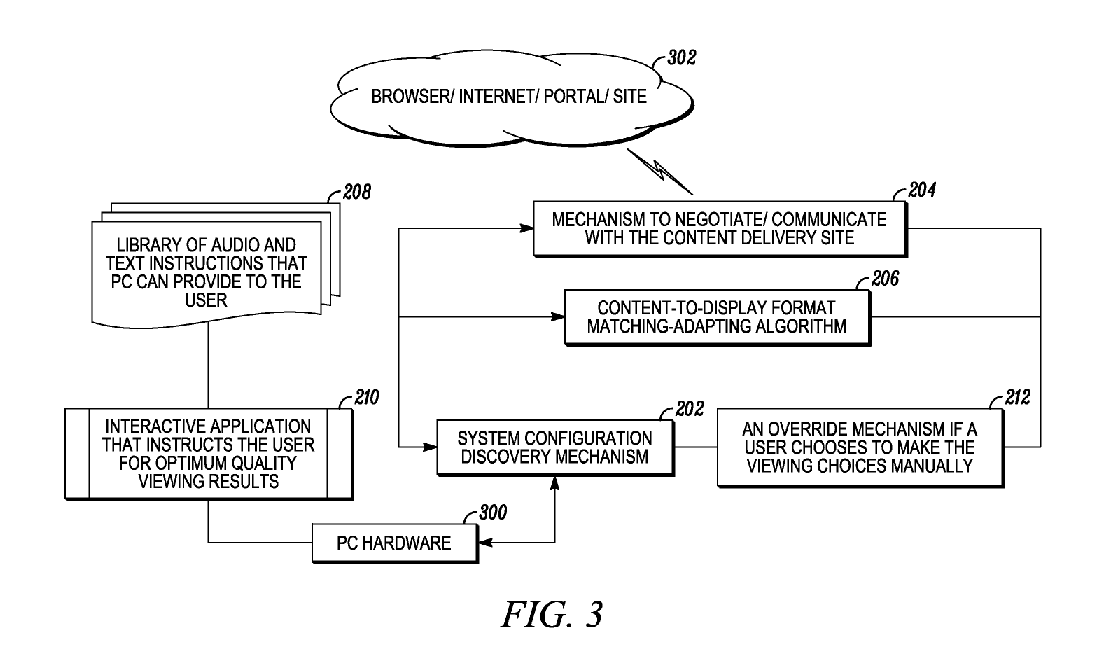

Referring now to FIG. 3, the modules described above are illustrated in one possible system configuration. A computer device 300, such as a PC or any other device capable of connecting to a network, such as the Internet 302, with a browser or other means is provided that has access to a plethora of multi-media files including 3D video content files. The system configuration discovery mechanism 202 may be provided to determine the viewing capabilities of the computer 300.

The negotiation/communication mechanism 204 may communicate with the content delivery site 302 to determine available formats of the stereoscopic content to be viewed. The Content-to-display format matching-adapting mechanism 206 is available to match the format of the stereoscopic content from the site to the capabilities of the computer 300. The library of audio and text instructions 208 available to the computer 300 may be provided to the user to instruct them on the optimum method for viewing the video. The interactive application 210 that may run on the computer 300 provides instructions from the library 208 to the user on the optimum way to view the video. The override mechanism 212 may also run on the computer 300 to allow the user to make viewing choices manually.

Thus, according to embodiments, the invention automatically discovers the PC system configuration and content formats being delivered, and using a set of content-to-display format matching, adapts the content for best viewing quality for the user. The interactive application backed by a library instructs the user to setup the viewing configuration and conditions for optimum quality, removing the confusion choices can produce otherwise.

Embodiments may be middleware that can be embedded between the internet browser and the graphics driver or can also be implemented as an extension to the graphics driver or as an extension of the browser.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a computer device for viewing a 3D video presentation from a web site;
a configuration and discovery module for determining viewing capabilities of the computer;
a negotiation module to negotiation with the web site to determine available formats of the 3D video presentation; and
a format matching module to match the viewing capabilities of the computer to the available formats of the 3D video presentation for optimum viewing.

2. The apparatus as recited in claim 1, further comprising:
a library of viewing instructions; and
an interactive application running on the computer to provide a user with the instructions for optimum viewing.

3. The apparatus as recited in claim 1, further comprising:
an override module to allow a user to make manual viewing choices.

4. The apparatus as recited in claim 1 wherein the modules exist in middleware between a browser and a graphics driver.

5. The apparatus as recited in claim 1 wherein the modules are part of an internet browser.

6. The apparatus as recited in claim 1 wherein the modules are part of a graphics driver.

7. A method, comprising:
providing a computer device for viewing a 3D video presentation from a web site;
determining viewing capabilities of the computer;
negotiating with the web site to determine available formats of the 3D video presentation;
matching the viewing capabilities of the computer to the available formats of the 3D video presentation for optimum viewing.

8. The method as recited in claim 7, further comprising:
providing a library of viewing instructions; and
providing a user with the instructions from the library for optimum viewing.

9. The method as recited in claim 7 further comprising:
providing an override module to allow a user to make manual viewing choices.

10. The method as recited in claim 8 wherein steps are carried out by middleware between a browser and a graphics driver.

11. The method as recited in claim 8 wherein steps are carried out by an internet browser.

12. The method as recited in claim 8 wherein steps are carried out by a graphics driver.

13. A system, comprising:
a computer device for viewing a 3D video presentation from a web site over the Internet;
a configuration and discovery module for determining viewing capabilities of the computer;
a negotiation module to negotiation with the web site to determine available formats of the 3D video presentation;
a format matching module to match the viewing capabilities of the computer to the available formats of the 3D video presentation for optimum viewing;
a library of viewing instructions; and
an interactive application running on the computer to provide a user with the instructions for optimum viewing.

14. The system as recited in claim 13, wherein the library viewing instructions comprises text and video instructions.

15. The system as recited in claim 13 further comprising an override module to allow a user to make manual viewing choices.

16. The system as recited in claim 13 wherein the modules exist in middleware between a browser and a graphics driver.

17. The system as recited in claim 13 wherein the modules are part of an internet browser.

18. The system as recited in claim 13 wherein the modules are part of a graphics driver.
